(19) United States
(12) Patent Application Publication
(10) Pub. No.: US 2026/0284631 A1
(43) Pub. Date: Sep. 24, 2026

(54) PHOTOREACTOR ASSEMBLY

(71) Applicant: SIGNIFY HOLDING B.V., EINDHOVEN (NL)

(72) Inventors: ANN WILHELMINA MARIA DE BEST, VELDHOVEN (NL); REMY CYRILLE BROERSMA, EINDHOVEN (NL); NORBERTUS ANTONIUS MARIA SWEEGERS, LIEROP (NL); ROBERT VAN ASSELT, VALKENSWAARD (NL); GRIGORY ALEXANDROVICH ONUSHKIN, EINDHOVEN (NL)

(21) Appl. No.: 19/472,181

(22) PCT Filed: Mar. 25, 2024
(86) PCT No.: PCT/EP2024/057907

§ 371 Date: Oct. 3, 2025

(30) Foreign Application Priority Data
Apr. 4, 2023 (EP) 23166425.1

(51) Int. Cl. B01J 19/12; B01J 19/00

(52) U.S. Cl. CPC B01J 19/123; B01J 19/0006; B01J 19/127; B01J 19/128; B01J 2219/00162; B01J 2219/0801; B01J 2219/0869; B01J 2219/0875

(57) ABSTRACT

The invention provides a photoreactor assembly comprising a reactor, a light source arrangement, and a reflector arrangement; wherein: (a) the light source arrangement comprises a plurality of solid state light sources configured to generate light source radiation selected from one or more of UV radiation, visible radiation, and IR radiation; wherein each solid state light source comprises a light emitting surface; wherein the solid state light sources have shortest heart-to-heart distances (p0); (b) the reactor is configured for hosting a fluid to be treated with the light source radiation; wherein the reactor comprises one or more reactor walls and a light transmissive reactor window; wherein the light transmissive reactor window is configured in a radiation receiving relationship with the solid state light sources, and is transmissive for the light source radiation; (c) the solid state light sources of the light source arrangement are configured at a second distance (h) from the light transmissive reactor window; (d) the reflector arrangement comprises one or more reflectors; wherein the one or more reflectors are selected such that a reflection of the light source radiation under perpendicular irradiation of the one or more reflectors is at least 90%; (e) the one or more reflectors, the light source arrangement, and the light transmissive reactor window form at least part of a light chamber; wherein the one or more reflectors are configured to prevent escape from at least part of the light source radiation from the light chamber; and (f) a shortest third distance (d) between the solid state light sources and the one or more reflectors is selected from the range of 0*p0-5*p0, and the second distance (h) is selected from the range of p0-25*p0.

### FIELD OF THE INVENTION

The invention relates to a photoreactor assembly comprising a reactor and a light source arrangement. The invention further relates to a method for treating a fluid with light source radiation.

### BACKGROUND OF THE INVENTION

Photoreactor assemblies are known in the art. For instance, US20100247401A1 describes a device for performing radiation assisted chemical processing including a fluid path, defined at least in part by a first surface of a wall transparent to radiation useful for performing radiation assisted chemical processing, and a gas discharge or plasma chamber arranged for producing the radiation, wherein the chamber is defined at least in part by a second surface of the transparent wall, opposite the first. It further describes a related method of forming a photocatalytic reactor comprising among other steps the step of wash-coating the fluid path so as to deposit a photocatalytic material therein, wherein the step of wash-coating includes depositing, and not depositing or removing photocatalytic material, respectively, on a first portion or from a second portion of the of non-circular cross section of the path, the second portion including at least some of the first surface of the wall of transparent material.

### SUMMARY OF THE INVENTION

Photochemical processing or photochemistry relates to the chemical effect of light. More in general, photochemistry refers to a (chemical) reaction caused by absorption of light, especially ultraviolet light (radiation), visible light (radiation) and/or infrared radiation (light). Photochemistry may for instance be used to synthesize specific products. For instance, isomerization reactions or radical reactions may be initiated by light. Other naturally occurring processes that are induced by light are e.g. photosynthesis, or the formation of vitamin D with sunlight. Photochemistry may further e.g. be used to degrade/oxidize pollutants in water or e.g. air. Photochemical reactions may be carried out in a photochemical reactor or “photoreactor”.

One of the benefits of photochemistry is that reactions can be performed at lower temperatures than conventional thermal chemistry and partly for that reason thermal side reactions that generate unwanted by-products are avoided.

Furthermore, commonly used light sources in photochemistry may include low or medium pressure mercury lamps or fluorescent lamps. In addition to that, some reactions may require a very specific wavelength region, and they may even be hampered by light from the source emitted at other wavelengths. In these cases, part of the spectrum may have to be filtered out, which may lead to a low efficiency and complex reactor design.

In the recent years the output of Light Emitting Diodes (LEDs), both direct LEDs with dominant wavelengths ranging for instance from UVC to IR wavelengths, and phosphor-converted LEDs, has increased drastically, making them interesting candidates for light sources for photochemistry. High fluxes can be obtained from small surfaces, especially if the LEDs can be kept at a low temperature.

In prior art systems, a substantial proportion of the light source radiation may be unused, i.e., it does not interact with reagents/fluid in the reactor, but may instead leave the system, may be lost due to Fresnel reflection and/or may be absorbed by other elements in the system. In particular, the light source radiation may be absorbed, which may result in excessive heat being produced in the photoreactor assembly, which in turn may result in unwanted by-products and/or a reduction in the efficiency of the LEDs. Further, the light source radiation may have a relatively low uniformity, which may result in local variations in exposure and therefore less reliable results.

Hence, it is an aspect of the invention to provide an alternative photoreactor assembly, which preferably further at least partly obviates one or more of above-described drawbacks. The present invention may have as object to overcome or ameliorate at least one of the disadvantages of the prior art, or to provide a useful alternative.

Hence, in a first aspect, the invention may provide a photoreactor assembly (also “reactor assembly” or “assembly”) comprising a reactor, a light source arrangement, and a reflector arrangement. Especially, the light source arrangement may in embodiments comprises a plurality of solid state light sources (e.g. at least at least 20 solid state light sources or e.g. at least 50 solid state light sources) configured to generate light source radiation selected from one or more of UV radiation, visible radiation, and IR radiation. Especially, each (solid state) light source may comprise a light emitting surface. Further, especially the solid state light sources have shortest heart-to-heart distances (p₀). In embodiments the solid state light sources may be configured in an n*m array, wherein one of n and m may be at least 1, more especially at least 2, and another one of n and m may be at least 5. Further, the reactor may be configured for hosting a fluid to be treated with the light source radiation. IN embodiments, the solid state light sources of the light source arrangement may be configured at a second distance (h) from (i) a light transmissive reactor window (downstream of which the fluid may be configured) or (ii) reactor sections comprised by a reactor support body (comprising an array of such reactor sections. In embodiments, the reflector arrangement may comprise one or more reflectors. Especially, the one or more reflectors may be selected such that a reflection of the light source radiation under perpendicular irradiation of the one or more reflectors may be at least 60%, more especially at least 80%, yet more especially at least 90%. Especially, at least part of the light source radiation may be received by the light transmissive window or reactor sections after reflection at the one or more reflectors. Further, in embodiments, a shortest third distance (d) between the solid state light sources and the one or more reflectors is selected from the range of 0*p₀-5*p₀, such as from the range of 0*p₀-0.9*p₀, and the second distance (h) may be selected from the range of p₀-25*p₀. Further, the invention provides in an aspect a photoreactor assembly comprising a reactor, a light source arrangement, and a reflector arrangement. In embodiments, the light source arrangement may comprise a plurality of light sources, especially a plurality of solid state light sources, configured to generate light source radiation (or: “light source light”). Especially, the light source radiation may in embodiments be selected from one or more of UV radiation, visible radiation, and IR radiation. Each (solid state) light source may in embodiments comprise a (respective) light emitting surface. The solid state light sources may have shortest heart-to-heart distances (p₀ ). The reactor may especially be configured for hosting a fluid to be treated with the light source radiation. The reactor may in embodiments comprise one or more reactor walls and a light transmissive reactor window. The light transmissive reactor window may in embodiments be configured in a radiation receiving relationship with the solid state light sources. Especially, the light transmissive reactor window may be transmissive for the light source radiation. The solid state light sources of the light source arrangement may be configured at a second distance (h) from the light transmissive reactor window. The reflector arrangement may in embodiments comprise one or more reflectors. The one or more reflectors may in embodiments be selected such that a reflection of the light source radiation under perpendicular irradiation of the one or more reflectors may be at least 60%, more especially at least 80%, yet more especially at least 90%. Especially, the one or more reflectors, the light source arrangement, and the light transmissive reactor window may in embodiments form at least part of a light chamber. The one or more reflectors may in embodiments be configured to prevent escape from at least part of the light source radiation from the light chamber. In embodiments, a shortest third distance (d) between the solid state light sources and the one or more reflectors may be selected from the range of 0*p₀-5*p₀, such as from the range of 0*p₀-0.9*p₀. In further embodiments, the second distance (h) may be selected from the range of p₀-25*p₀. Hence, in specific embodiments, the invention may provide a photoreactor assembly comprising a reactor, a light source arrangement, and a reflector arrangement; wherein: (a) the light source arrangement comprises a plurality of solid state light sources configured to generate light source radiation selected from one or more of UV radiation, visible radiation, and IR radiation; wherein each (solid state) light source comprises a light emitting surface; wherein the solid state light sources have shortest heart-to-heart distances (p₀); (b) the reactor is configured for hosting a fluid to be treated with the light source radiation; wherein the reactor comprises one or more reactor walls and a light transmissive reactor window; wherein the light transmissive reactor window is configured in a radiation receiving relationship with the solid state light sources, and is transmissive for the light source radiation; (c) the solid state light sources of the light source arrangement are configured at a second distance (h) from the light transmissive reactor window; (d) the reflector arrangement comprises one or more reflectors; wherein the one or more reflectors are selected such that a reflection of the light source radiation under perpendicular irradiation of the one or more reflectors is especially at least 90%; (e) the one or more reflectors, the light source arrangement, and the light transmissive reactor window form at least part of a light chamber; wherein the one or more reflectors are configured to prevent escape from at least part of the light source radiation from the light chamber; and (f) a shortest third distance (d) between the solid state light sources and the one or more reflectors is selected from the range of 0*p₀-0.9*p₀, and the second distance (h) is selected from the range of p₀-25*p₀.

The light source radiation of the photoreactor assembly of the invention may provide a (relatively) high uniformity, which may prevent or reduces local variations in exposure and therefore results in a high efficiency and reliable results. Especially, the photoreactor assembly of the invention may be relatively highly efficient in terms of light source radiation usage versus power input of the light sources. More especially, the photoreactor assembly of the invention may provide relatively homogeneous light source radiation in terms of intensity and/or wavelength. In particular, the photoreactor assembly may be highly efficient in capturing of the radiation by the fluid, especially by reactants in the fluid. In the reactor, reactions may be executed more efficiently and more homogeneously compared to prior art solutions. Hence, a higher yield (per time unit and/or per power unit) of the desired product may be obtained in the reactor assembly compared to prior art systems.

Hence, the invention may provide a photoreactor assembly. The photoreactor assembly may be used for treating a (reactor) fluid with light source radiation, such as in the method of the invention (see below). The term “treating the fluid (with light source radiation)”, and similar phrases, may especially relate to irradiating the fluid with the light source radiation. The fluid especially comprises a photosensitive reactant (including photocatalyst and/or photosensitizer), especially sensitive to the light source radiation (see below). The term “(reactor) fluid” may relate to a plurality of (different) fluids. Further, the fluid may comprise a liquid and/or a gas. Moreover, the fluid may in embodiments enter the reactor as a liquid and may in specific embodiments (partly) become gaseous when being heated in the reactor. The plurality of different fluids may be mixed and (configured to) provide a homogenous flow in the reactor during operations. In further embodiments the plurality of different fluids may be selected to provide a segmented flow in the reactor during operations. The plurality of fluids may further be selected for providing slug flow in the reactor during operations. However, the invention also includes embodiments wherein the fluid, especially a liquid, may not substantially flow during the reaction process, like e.g. a multi-well reactor or other type of reactor. Hence, the fluid may have a liquid phase, a gaseous phase or a combination of liquid and gaseous phases. The fluid may comprise a mix of different fluids. The fluid may in embodiments comprise a homogenous mixture of different fluids. In further embodiments, the fluid may comprise a heterogenous mixture of fluids. Especially, the term “fluid” may herein at least comprise a liquid.

As indicated above, the photoreactor assembly may comprise a reactor, a light source arrangement, and a reflector arrangement. Each component will be discussed here in more detail.

The term “reactor” may especially relate to a (photo)chemical reactor. The term essentially relates to an enclosed (reactor) chamber in which a (photochemical) reaction may take place. The reactor chamber may especially have a reactor volume. The reactor may be configured for hosting the (reactor) fluid to be treated with the light source radiation. The reactor may in embodiments comprise one or more reactor walls. In further embodiments, the reactor may comprise a light transmissive reactor window. The light transmissive reactor window may be configured in a radiation receiving relationship with the (solid state) light sources. In further embodiments, the light transmissive reactor window may be transmissive for the light source radiation. In this way, at least part of the light source radiation may be transmitted through the light transmissive reactor window and reach the fluid. In embodiments, at least 70%, such as at least 80%, such as at least 90% of the light source radiation may be transmitted through the light transmissive reactor window. Especially, the reactor may be configured for hosting the fluid to be treated with the light source radiation.

The invention may be applied for different types of reactors, such as plate reactors, multi-channel reactors, and multi-well reactors. Here below, some general aspects and embodiments are described.

In particular, the reactor may comprise a reactor chamber, especially a reactor channel, configured for hosting the fluid. The term “reactor channel” may herein especially refer to a reactor chamber having an elongated shape, especially wherein, during use, the fluid flows from one end of the reactor chamber to another end of the reactor chamber. Hence, the length of the reactor channel may especially be larger than a (circular equivalent) (inner) diameter of the reactor channel. A ratio of the length of the reactor channel to the (circular equivalent) (inner) diameter of the reactor channel may in embodiments be larger than 5, especially larger than 10. The reactor may comprise one or more reactor walls. The one or more reactor walls may define the reactor chamber, especially the reactor channel. In embodiments, the reactor chamber, especially the reactor channel, may have a flow path, especially wherein the flow path meanders. The flow path may meander in a first dimension. The flow path may further meander in a second dimension, which may be perpendicular to the first dimension. The meandering may especially contribute to providing turbulence in the reactor chamber. In alternative embodiments, the flow path may be straight. The one or more reactor walls, especially the at least one of the one or more reactor walls, may especially have an average reactor wall thickness selected from the range of 0.4-25 mm, especially from the range of 0.5-25 mm, such as from the range of 0.7-20 mm. The reactor wall thickness may (at each location) especially be measured perpendicular to the surface of a reactor wall. Due corrugations in the reactor wall (see below), and optionally due to a meandering flow path of the fluid, the reactor wall thickness may not be constant along the reactor. In further embodiments, along at least 80% of the at least one of the one or more reactor walls, such as at least 90%, especially at least 95%, the at least one of the one or more reactor walls may have a reactor wall thickness of at least 1 mm, especially at least 2 mm, such as at least 5 mm. Further, in embodiments the light transmissive reactor window may have a thickness selected from the range of 0.4-25 mm, especially from the range of 0.5-25 mm, such as from the range of 0.7-20 mm.

In other embodiments, the reactor comprises one or more reactor walls, and may host a reactor support body. The reactor support body may comprise an array of reactor sections, like wells, cuvette-shaped reactors, etc. Hence, in embodiments the reactor support body may comprise a plurality of micro reactors. In embodiments, the reactor support body may be transmissive for the light source radiation. For instance, in this way the fluid in the reactor sections may be irradiated from below. However, in other embodiments, the reactor sections may also be irradiated from above. Hence, in embodiments the reactor may comprise a reactor support body comprising an array of reactor sections; wherein the photoreactor assembly is configured such that during operation of the photoreactor assembly, the reactor sections are irradiated with the light source light from above the reactor sections or from below the reactor sections.

The term “light source arrangement” may herein refer to the arrangement of a plurality of light sources, i.e., a spatial arrangement (relative to the reactor, especially to the reactor chamber). Hence, the light source arrangement may comprise a plurality of light sources. Especially, the light source arrangement may in embodiments comprise a plurality of (solid state) light sources. Here below, the invention is further especially explained in relation to solid state light sources (as example of light sources).

In embodiments, the light sources may be connected to one another, such as via a support element hosting the light sources. Hence, in further embodiments, the light source arrangement may comprise a support element, such as a plate-like support element, wherein the plurality of light sources are arranged on the support element. In embodiments, the support element may comprise a printed circuit board (PCB).

In embodiments (at least part of) the plurality of light sources may comprise Light Emitting Diodes (LEDs), especially an array of light emitting diodes. The term “array” may especially refer to a plurality of (different) arrays. In further embodiments (at least part of) the plurality of light sources comprise Chips-on-Board light sources (COB). The term “COB” especially refers to LED chips in the form of a semiconductor chip that is neither encased nor connected but directly mounted onto a substrate, such as a Printed Circuit Board. The COB and/or LED may in embodiments comprise a direct LED (with dominant wavelengths ranging for instance from UVC to IR wavelengths) In further embodiments, the COB and/or LED comprises one or more phosphor-converted LEDs. Using such light sources, high intensity radiations (light) may be provided per light source or per light source (support) element (see below). In embodiments, e.g., the light sources may provide 100-25,000 lumen (visible light) per light source. In embodiments, the light sources may e.g. apply (consume) 0.5-500 (electrical) Watts per light source (input power).

In embodiments, the plurality of (solid state) light sources may comprise (single) chips-on-board light sources and/or (single) light emitting diodes, and/or (single) laser diodes. In further embodiments, the light sources may comprise an array of light emitting diodes and/or laser diode sources. Hence, in embodiments the plurality of light sources may comprise one or more of chips-on-board light sources, light emitting diodes, and laser diodes. In further embodiments, the plurality of light sources comprise chips-on-board light sources and/or an array of light emitting diodes.

The light sources may especially be configured to generate light source radiation, especially light source radiation selected from one or more of UV radiation, visible radiation, and IR radiation. In embodiments, the light source radiation may comprise UV radiation. The light source radiation may in further embodiments (also) comprise visible radiation. In yet further embodiments, the light source radiation may (also) comprise IR radiation.

The term “UV radiation” is known to the person skilled in the art and relates to “ultraviolet radiation”, or “ultraviolet emission”, or “ultraviolet light”, especially having one or more wavelengths in the range of about 10-400 nm, or 10-380 nm. In embodiments, UV radiation may especially have one or more wavelength in the range of about 100-400 nm, or 100-380 nm. Moreover, the term “UV radiation” and similar terms may also refer to one or more of UVA, UVB, and UVC radiation. UVA radiation may especially refer to having one or more wavelengths in the range of about 315-400 nm. UVB radiation may especially refer to having one or more wavelengths in the range of about 280-315 nm. UVC radiation may further especially have one or more wavelengths in the range of about 100-280 nm. In embodiments, the light sources may be configured to provide light source radiation having wavelengths larger than about 190 nm. The terms “visible”, “visible light”, “visible emission”, or “visible radiation” and similar terms refer to light having one or more wavelengths in the range of about 380-780 nm. The term “IR radiation” especially relates to “infrared radiation”, “infrared emission” , or “infrared light”, especially having one or more wavelengths in the range of 780 nm to 1 mm. Moreover, the term “IR radiation” and similar terms may also refer to one or more of NIR, SWIR, MWIR, LWIR, FIR radiation. NIR may especially relate to Near-infrared radiation having one or more wavelength in the range of about 750-1400 nm. SWIR may especially relate to Short-wavelength infrared having one or more wavelength in the range of about 1400-3000 nm. MWIR may especially relate to Mid-wavelength infrared having one or more wavelength in the range of about 3000-8000 nm.

LWIR may especially relate to Long-wavelength infrared having one or more wavelength in the range of about 8-15 μm. FIR may especially relate to Far infrared having one or more wavelength in the range of about 15-1000 μm.

In embodiments, each (solid state) light source may comprise a (respective) light emitting surface. The term “light emitting surface” may herein refer to the surface of the light source from which light source radiation is emitted. Especially, in embodiments the light emitting surface may be the (top) surface of a diode, such as an LED, a laser, or a superluminescent diode. In embodiments, the light emitting surface may be planar. In further embodiments, the light emitting surface may be curved, especially convex, or especially concave.

Further, the light sources, especially the light emitting surfaces of the light sources, may be arranged such that the vast majority, essentially all, emitted light source radiation is directed towards the reactor chamber, especially towards reactor fluid in the reactor chamber. So essentially all fluid that is in the reactor and/or that passes through the reactor may interact with the light source radiation.

In embodiments, each (solid state) light source may have an optical axis, wherein the light source emits essentially all of the light source radiation, such as at least 90% of the light source radiation, especially at least 95% of the light source radiation, such as at least 99% of the light source radiation, including 100%, at angles less than 120°, such as less than 100°, especially less than 90°, from the optical axis.

In embodiments, each (solid state) light source may have essentially Lambertian emission characteristics, i.e., the light source emits essentially all of the light source radiation at angles less than 90° with respect to the optical axis.

Especially, the optical axis may be defined as an imaginary line that defines the (weighted average) path along which light propagates through the system starting from the light generating element, here especially the light source. Hence, the optical axis may especially coincide with a weighted average path of the emitted light source radiation. In general, the optical axis may coincide with the normal to a central position of the light emitting surface.

As indicated above, in embodiments, the photoreactor assembly may further comprise a reflector arrangement. The reflector arrangement may in embodiments especially comprise one or more reflectors. In embodiments, the one or more reflectors may be selected such that a reflection of the light source radiation under perpendicular irradiation of the one or more reflectors may be at least 60%, such as at least 70%, in further embodiments at least 80%, especially at least 85%, such as at least 90%, more especially at least 95%. In specific embodiments, the one or more reflectors may comprise a specular reflector. The reflector arrangement may e.g. comprise a (reflective) coating, a reflective foil, or a reflective surface. In embodiments, the object comprising the one or more reflectors may (at least partly) be made of reflective material. For instance, the object may be made of a reflective metal, or another (non-metal type) material that may reflect the light source radiation. The one or more reflectors may further comprise an optical layer. At least part of the one or more reflectors may further comprise one or more of boron nitride (BN), alumina (Al₂O₃), aluminum, dichroic layers, a reflective polymer, and titanium dioxide (TiO₂). The optical layer may comprise a silver comprising layer (or “silver reflector”), or a dichroic layer. The optical layer may in embodiments comprise an anodized layer. The layer may comprise (micro porous) polytetrafluoroethylene (PTFE). In embodiments, the one or more reflectors may comprise one or more of aluminum, boron nitride, alumina, silver, a dichroic layer, and (micro porous) PTFE. Examples of very suitable reflectors include e.g. Alanod Miro95 or Alanod Miro98, or similar high reflective materials. Other suitable examples may include 3M Mirror or 3M Vikuiti. Especially, the entire (one or more) reflector(s) are specular reflective.

Especially, the one or more reflectors may be configured such that at least part of the light source radiation may be received by the light transmissive window (or reactor sections; see also below) after reflection at the one or more reflectors. Hence, in embodiments at least part light source radiation may be received by the light transmissive window (or reactor sections; see also below) directly, at least part light source radiation may be received by the light transmissive window (or reactor sections; see also below) after at least one reflection at the one or more reflectors.

In embodiments, the one or more reflectors may form a cavity. In specific embodiments, the one or more reflectors may form a hollow reflector body. The hollow reflector body may have a circular cross-section, but may also have a substantially rectangular cross-section. In the latter embodiment, e.g. four reflectors may be used.

However, also one reflector may be shaped into a reflector forming a hollow reflector body having a substantially rectangular cross-section. The edges of the hollow reflector body may be rounded.

In embodiments, the one or more reflectors, the light source arrangement, and the light transmissive reactor window may form at least part of a light chamber. Especially, the one or more reflectors, the light source arrangement, and the light transmissive reactor window may in embodiments define at least part of the light chamber. Especially, the one or more reflectors may in embodiments be configured to prevent escape from at least part of the light source radiation from the light chamber. In other words, the radiation may be received by the reactor or reactor sections directly or after one or more reflections at the one or more reflectors.

In embodiments, the second distance (h) may be selected from the range of 0.5-25 cm, such as 1-20 cm, such as in embodiments from the range of 3-15 cm, especially from the range of 4-12 cm. However, other values are herein not excluded. Especially, the second distance is the height from one or more light emitting surface of from the light sources to the light transmissive reactor window. Note that a chamber wherein the light sources are configured may (thus) be higher.

The one or more reflectors may have a reflector height (r), a reflector length (LR), and a reflector thickness (t). In embodiments, the reflector height (r) may be selected from the range of 0.5-25 cm, such as 1-20 cm, such as in embodiments from the range of 3-15 cm, especially from the range of 4-12 cm. The reflector height (r) may especially refer to the height of the reflector over the second distance (h). In other words, would the reflector extend beyond the second distance, then essentially only the overlapping length of the reflector may be taken as reflector height. For instance, this may be when the light sources are configured (suspended) at a substantial distance from a top face, but the reflector would extend from the top face. Especially, as indicated above, the second distance (h) is determined from a light emitting surface of one or more of the light sources and the light transmissive reactor window.

Additionally or alternatively, the reflector length (L_{R}) may in embodiments be selected from the range of 5-30 cm, such as from the range of 8-25 cm, especially from the range of 10-20 cm. However, larger lengths may also be possible, such as up to about 200 cm. In embodiments, wherein the reflector(s) may define a reflector cavity, an inner perimeter of the reflector(s) may be selected from the range of 4-800 cm, such as 10-200 cm. Additionally or alternatively, in embodiments the reflector thickness (t) may be selected from the range of 1 μm- 1 cm, such as from the range of 0.1 mm- 8 mm.

Returning to the photoreactor assembly. The solid state light sources may have shortest heart-to-heart distances (p₀). Further, as indicated above, the solid state light sources of the light source arrangement may be configured at a second distance (h) from the light transmissive reactor window. Further, in embodiments the solid state light sources may be configured at a shortest third distance (d) from the one or more reflectors. The phrase “the solid state light sources may be configured at a shortest third distance (d) from the one or more reflector”, and similar phrases, may especially indicated that there are one or more light sources configured closest to the reflector, and those one or more light sources are configured at the shortest third distance (d). For instance, assuming an array of solid state light sources S1 . . . Sn configured (orthogonally) between two (parallelly configured) reflectors, S1 may be configured closest to one reflector and Sn may be configured closest to the other reflector. Hence, a shortest distance (d) may thus be the distance between S1 and the reflector configured closest to S1, and a shortest distance (d) may thus be the distance between Sn and the (other) reflector configured closest to Sn.

In embodiments, the shortest third distance (d) may be selected from the range of 0*p₀-10*p₀, such as from the range of 0*p₀-5*p₀. For instance, in embodiments the shortest third distance (d) may be selected from the range of 0.05*pₒ-10*p₀, like in embodiments 0.1*p₀-5*p₀, such as from the range of 0.1*p₀-5 *p₀, especially from the range of 0.2*p₀-1.2*p₀, more especially from the range of 0.4*p₀-0.6*p₀. It appears that such an optimized shortest third distance(d) may contribute to an even power distribution of the radiation, especially when 0.4*p₀≤d≤0.6*p₀. A value relatively close to 0.5*p₀ may provide a mirror image of the array at a distance of p₀. This may add to homogeneity of the radiant flux from the plurality of light sources.

Additionally or alternatively, the second distance (h) may in embodiments be selected from the range of 0.5*p₀-35*p₀, such as from the range of p₀-25*p₀, especially from the range of 2*p₀-25*p₀, more especially from the range of 3*p₀-20*p₀. In this way, the photoreactor system of the invention may increase the efficiency of light usage, while reducing undesired heat generation and providing homogeneous exposure of the fluid (comprising the reactants) to the light source radiation. Further, it appears that such an optimized second distance (h) may contribute to an even power distribution of the radiation.

In embodiments, the (plurality of) solid state light sources may be configured in an irregular pattern. Additionally or alternatively, the (plurality of) solid state light sources may be configured in a (almost) regular pattern, wherein up to five, such as up to three solid state light sources deviate from the regular pattern. In such embodiments, the shortest heart-to-heart distance (p₀) may be defined as an average of the individual shortest heart-to-heart distances.

In alternative embodiments, the (plurality of) solid state light sources may be configured in a regular pattern. In such embodiments, the individual shortest heart-to-heart distances may be substantially identical. Especially, such shortest heart-to-heart distances may be a smallest pitch (p). Hence, the shortest heart-to-heart distances (p₀) may be a smallest pitch (p) of the plurality of solid state light sources. In further embodiments, the one or more reflectors may have a reflector height (r). Especially, the reflector height (r) may in embodiments be selected from the range of at least 0.5*h, such as at least 0.7*h, especially at least 0.9*h, more especially at least 0.95*h. Hence, in specific embodiments, the shortest heart-to-heart distances (p₀) is a smallest pitch (p) of the plurality of solid state light sources. Further, in embodiments the one or more reflectors may have a reflector height (r), wherein the reflector height (r) may be selected from the range of at least 0.9*h. Especially, in embodiments r≤h. In some other embodiments, however, r≥h.

In embodiments, the solid state light sources may be configured in an n*m array, wherein one of n and m is at least 1, more especially at least 2, and another one of n and m is at least 5. Hence, in embodiments the solid state light sources may be configured in a 1*5 array or larger, more especially a 1*8 array, or larger, yet more especially a 1*10 array, or larger. Yet, in embodiments, the solid state light sources may be configured in a 2*5 or larger array. More especially, the solid state light sources may be configured in a 2*8 or larger array, like a 2*10 or a larger array. Other embodiments may also be possible, like e.g. 4*m, wherein m is at least 5, more especially at least 8.

A reflector next to a row of solid state light sources, such as LEDs, could create a virtual pitch (the image of the row of solid state light sources, such as LEDs, may be at two times the distance between the real row and the reflector). When n=1, the distance of the single row to the reflector may in embodiments also be selected from 0.5-5 times the pitch.

In embodiments, the photoreactor assembly may comprise at least 25 solid state light sources, such as at least 40 solid state light sources, such as at least 50 solid state light sources. In specific embodiments, the system may comprise at least 80 solid state light sources, such as at least 100.

In a square array, i.e. an array wherein the light sources are configured at edges of a square, there may be two identical orthogonal pitches. In embodiments, the array may be a square array. In a non-square array, there may be two different pitches, of which one may be indicated as smallest pitch, see further also below.

As indicated above, the one or more reflectors, the light source arrangement, and the light transmissive reactor window may in embodiments form at least part of a light chamber. In further embodiments, the one or more reflectors, the light source arrangement, and the light transmissive reactor window form the light chamber. As also indicated above, the one or more reflectors may in embodiments be configured to prevent escape from at least part of the light source radiation from the light chamber. Hence, in specific embodiments the one or more reflectors, the light source arrangement, and the light transmissive reactor window form the light chamber, wherein the one or more reflectors may (especially) be configured to prevent escape from at least part of the light source radiation from the light chamber.

In embodiments, the array may have width L perpendicular to an axis of elongation of the photoreactor assembly. In embodiments, the reactor may have width f perpendicular to an axis of elongation of the photoreactor assembly. In specific embodiments, 0.5≤L/f≤1, such as 0.7≤L/f≤0.99, like as 0.8≤L/f≤0.98. Other values, however, may also be possible.

The light chamber may in embodiments have one or more openings. Such openings may be configured as an inlet for a gas and/or an outlet for the gas. Especially, the one or more openings may have cross-sectional areas A1 having circular equivalent diameters Dᵢ. In embodiments, ΣDᵢ≤6*p0, like ΣDᵢ≤5*p0, such as especially ΣDᵢ≤3*p0, such as ΣDᵢ≤2*p0, especially ΣDᵢ≤p0. Hence, in specific embodiments the light chamber has one or more openings; wherein the one or more openings have cross-sectional areas A1 having circular equivalent diameters Dᵢ, wherein ΣDᵢ≤2*p0.

The equivalent circular diameter (or ECD) (or “circular equivalent diameter”) of an (irregularly shaped) two-dimensional shape is the diameter of a circle of equivalent area. For instance, the equivalent circular diameter of a square with side a is 2*a*SQRT(1/π). For a circle, the diameter is the same as the equivalent circular diameter. Would a circle in an xy-plane with a diameter D be distorted to any other shape (in the xy-plane), without changing the area size, than the equivalent circular diameter of that shape would be D.

Especially, in embodiments wherein the light chamber may have one or more openings, wherein the one or more openings have cross-sectional areas A1 having circular equivalent diameters Dᵢ, such that a sum of the area of all openings (Σ(π*(Dᵢ/2)²) is equal to or less than 5% of the total reflector area, more especially equal to or less than 1% of the total reflector area, such as selected from the range of 0.01-1%. For the definition of the total reflector area, also the reflector height as defined above may be applied. Hence, the total reflector area may defined by a perimeter of the reflector and the reflector height. A small relative opening area may provide a low impact on the reflection.

As indicated above, the one or more openings may be configured as an inlet for a gas and/or an outlet for the gas. In such embodiments, the photoreactor assembly may further comprise one or more of a gas source and a gas transport system. In embodiments, the gas transport system may be fluidically coupled with at least one opening of the one or more openings. In further embodiments, the gas transport system may fluidically couple the gas source and at least one opening of the one or more openings. Especially, the gas source and gas transport system may in embodiments be configured to flow an inert gas, during an operational mode of the photoreactor assembly into the light chamber. The inert gas may in embodiments comprise one or more of helium, argon, nitrogen, Hence, in specific embodiments the photoreactor assembly further comprises a gas source and a gas transport system, wherein the gas transport system is fluidically coupled with at least one opening of the one or more openings, and wherein the gas source and gas transport system are configured to flow an inert gas, during an operational mode of the photoreactor assembly into the light chamber. The inert gas may in embodiments provide cooling of the photoreactor assembly.

In embodiments, the reactor assembly may further comprise a control system or may be functionally coupled to a control system. Especially, the control system may be configured to maintain a pressure in the light chamber of up to 5 bar, such as in embodiments selected from the range of 1.5-5 bar. In embodiments, this may add to the safety of the reactor assembly. Further, in embodiments the reactor assembly, especially the gas transport system, may be equipped with a valve which can either be open to have a gas flow in the light chamber, or can be closed to maintain a gas pressure up to 5 bar such as in embodiments selected from the range of 1.5-5 bar. In other embodiments, the control system may be configured to maintain a pressure in the light chamber below 1 bar, such as below about 0.9 bar.

In embodiments, the control system may be configured to maintain an overpressure in the light chamber of up to 5 bar, such as in embodiments selected from the range of 1.5-5 bar. In embodiments, this may comprise maintaining the pressure in the light chamber at a pressure of 1.5-5 bar higher than the pressure in the reactor chamber. In embodiments, this may add to the safety of the reactor assembly, by preventing the leaking of fluids into the light chamber. Further, in embodiments the reactor assembly, especially the gas transport system, may be equipped with a valve which can either be open to have a gas flow in the light chamber, or can be closed to maintain a gas overpressure up to 5 bar such as in embodiments selected from the range of 1.5-5 bar.

In further embodiments, the light chamber may comprise a first light chamber and a second light chamber. The first light chamber and the second light chamber may in embodiments be separated by a light source arrangement window. Especially, the light emitting surface of the plurality of light sources may be configured in the first light chamber. Hence, in embodiments the light source arrangement and the light source arrangement window may at least partly define the first light chamber. The first light chamber may in embodiments comprise at least part of the one or more reflectors. Especially, both the first light chamber and the second light chamber may comprise at least part of the one or more reflectors. Even more especially, the wall(s) of the first light chamber and the wall(s) of the second light chamber may comprise the reflector(s).

The second light chamber may in embodiments be at least partly defined by the light transmissive reactor window and the light source arrangement window. As indicated above, the second light chamber may in embodiments comprise at least part of the one or more reflectors. Hence, in specific embodiments the photoreactor assembly may comprise a first light chamber and a second light chamber, separated by a light source arrangement window; wherein the light emitting surface of the plurality of light sources are configured in the first light chamber; wherein the second light chamber is at least partly defined by the light transmissive reactor window and the light source arrangement window; and wherein the first light chamber comprises at least part of the one or more reflectors and/or wherein the second light chamber comprises at least part of the one or more reflectors. Such light source arrangement window may protect one or more of the plurality of light sources and the reflector arrangement from damage and/or dirt. In alternative embodiments, the light chamber may not comprise a light source arrangement window. In such embodiments, the light chamber may be a single light chamber. As indicated above, the (single) light chamber may comprise the one or more reflectors.

As indicated above, the light chamber may be provided with a gas, especially an inert gas. When there are effectively two light chambers, such inert gas may be provided to one or more of these light chambers. Hence, in embodiments, the first light chamber may comprise one or more openings. Alternatively or additionally, in embodiments, the second light chamber may comprise one or more openings. In embodiments, the gas transport system may be fluidically coupled with one or more of the first light chamber and the second light chamber.

Hence, in embodiments, the inert gas (in the first light chamber) may especially be used to cool the light source arrangement. Additionally or alternatively, the inert gas (in the first light chamber) may protect the plurality of (solid state) light sources. In such embodiments, the inert gas may especially comprise e.g. one or more of nitrogen and argon, though other gasses may also be possible, like helium. Especially, the gas may comprise at least 98 vol. % inert gas, such as at least about 99 vol. %, and optionally some (i.e. especially at maximum 2 vol. %) other (non-inert) gasses, oxygen. Additionally or alternatively, in embodiments the second light chamber may comprise one or more openings. In embodiments, one or more of the one or more openings may comprise a valve. In embodiments, the gas transport system may be fluidically coupled with the second light chamber. In such embodiments, the inert gas may especially cool the reactor chamber. Additionally or alternatively, the inert gas (in the second light chamber) may provide a contra-pressure to a pressure in the reactor chamber (see below) to increase safety. The contra-pressure (in the second light chamber) may be selected from the range of 1-40 bar, such as from the range of 1-30 bar, especially from the range of 1-20 bar, more especially from the range of 1-10 bar. Hence, in specific embodiments the gas transport system is fluidically coupled with one or more of the first light chamber and the second light chamber.

As indicated above, the gas transport system may be fluidically coupled to the first light chamber and/or to the second light chamber. In such embodiments, the gas source may comprise a first gas source and a second gas source. In further embodiments, the gas transport system may comprise a first gas transport system and a second gas transport system. Especially, the first gas transport system may in embodiments fluidically couple the first gas source with the first light chamber. Similarly, the second gas transport system may in embodiments fluidically couple the second gas source with the second light chamber. The first gas source and the second gas source may in embodiments comprise different types of gas. In alternative embodiments, the first gas source and the second gas source may in embodiments comprise the same (type of) gas. In yet alternative embodiments, a single gas source may be coupled with the first light chamber and the second light chamber via the gas transport system.

Therefore, in embodiments the photoreactor assembly may further comprise a gas source and a gas transport system, wherein the gas transport system is fluidically coupled with at least one opening of the one or more openings, and wherein the gas source and gas transport system may be configured to flow an inert gas, during an operational mode of the photoreactor assembly into at least part of the light chamber (which may in specific embodiments imply flowing the inert gas in one or more of the first light chamber and the second light chamber).

Hence, as also indicated above, in embodiments the photoreactor assembly may further comprise a control system configured to maintain a pressure in the first light chamber and/or the second light chamber of up to 5 bar, such as in embodiments selected from the range of 1.5-5 bar.

Hence, as also indicated above, in embodiments the photoreactor assembly may further comprise a control system configured to maintain an overpressure in the first light chamber and/or the second light chamber of up to 5 bar, such as in embodiments selected from the range of 1.5-5 bar.

In further embodiments, the photoreactor assembly may comprise a light generating unit. The light generating unit may in embodiments comprise the first light chamber and the light source arrangement window. Such light generating unit may be a single device, which may, together with a reflector frame element (see below), be used to provide the (first and second) light chamber. In embodiments, the light generating unit may be a closed unit, with the light source arrangement window as end window, from which, during operation of the light generating unit, light source radiation may emanate. The light generating unit may further comprise one or more walls, which may comprise at least part of the one or more reflectors.

Additionally or alternatively, the photoreactor assembly may in embodiments comprise a frame element (or reflector frame element). The frame element may in embodiments function as a light chamber wall. In further embodiments, the one or more reflectors may be configured on the frame element. In embodiments, the frame element, the light source arrangement window (of the light generating unit) and the light transmissive reactor window may define the second light chamber. In further embodiments, the frame element, the light source arrangement window, and the light source arrangement may define the first light chamber. Hence, in specific embodiments the photoreactor assembly comprises (a) a light generating unit, wherein the light generating unit comprises the first light chamber and the light source arrangement window, and (b) a frame element, wherein the frame element, the light source arrangement window of the light generating unit, and the light transmissive reactor window define the second light chamber.

The photoreactor assembly may in embodiments further comprise a pressurizing device. In embodiments, the pressurizing device may be configured to impose a pressure on the fluid during an operational mode of the photoreactor assembly of over 1 bar, such as up to about 40 bar. In specific embodiments the photoreactor assembly further comprises a pressurizing device, wherein the pressurizing device is configured to impose a pressure on the fluid during an operational mode of the photoreactor assembly of up to about 10 bar, such as selected from the range of 1-10 bar, like in specific embodiments at least about 1.5 bar, though lower values may also be possible. Such pressure may increase a flow speed of the fluid and hence shorten an exposure time of reactants to the light source light and/or increase throughput of the fluid through the reactor chamber. Note that in specific embodiments, the pressure in the reactor chamber may be less than 1 bar, especially when the fluid is gas, such as below 0.9 bar.

Especially in embodiments wherein the reactor chamber and/or fluid is pressurized, the photoreactor assembly may comprise strong structural components. In embodiments, the photoreactor assembly may comprise a holding structure. The holding structure may in embodiments comprise two parts comprising a first part (of the two parts) and a second part (of the two parts). The two parts may in embodiments be associated to each other via connector elements. Thus especially, the first part (of the two parts) and the second part (of the two parts) may in embodiments be associated to each other via connector elements. In embodiments, the light transmissive reactor window may be configured in contact with a first part of the two parts. The holding structure may in embodiments be configured to keep the light transmissive reactor window in place. In further embodiments, the first part (of the two parts) may comprise a hollow structure. In embodiments, the light source arrangement may be configured over the hollow structure. Additionally or alternatively, the light source arrangement may in embodiments be at least partly configured in the hollow structure. Hence, in specific embodiments the photoreactor assembly comprises a holding structure comprising two parts, associated to each other via connector elements; wherein the light transmissive reactor window is configured in contact with a first part of the two parts, and wherein the holding structure is configured to keep the light transmissive reactor window in place; wherein the first part comprises a hollow structure; wherein the light source arrangement is configured over the hollow structure or is at least partly configured in the hollow structure.

In further embodiments, the frame element may be configured in the hollow structure. Especially, the frame element may in embodiments comprise at least part of the one or more reflectors. Hence, in specific embodiments the frame element is configured in the hollow structure; and the frame element comprises at least part of the one or more reflectors. In this way, the holding structure may provide one or more of solidity and safety to the photoreactor assembly whilst allowing the light source light to reach the reactor chamber.

In other embodiments, the reflector may be provided as coating to the hollow structure (except for the light transmissive reactor window).

As indicated above, the reactor assembly may comprise a light chamber wherein a reactor support body may be configured. The reactor support body may comprise an array of reactor sections; wherein the photoreactor assembly may be configured such that during operation of the photoreactor assembly, the reactor sections may be irradiated with the light source light from above the reactor sections or from below the reactor sections. In embodiments, the reactor support body may be transmissive for the light source radiation, especially (light) transparent.

The array of reactor sections may be an n1*m1 array, wherein one of n1 and m1 is at least 1, more especially at least 2, and another one of n1 and m1 may be at least 2. Especially, in embodiments both n1 and m1 may be at least 2, more especially both may be at least 4.

In embodiments, heat may be generated in the photoreactor assembly. In embodiments, the photochemical reaction may be exothermic. Additionally or alternatively, the light source arrangement may generate heat. For one or more of safety and lifetime, it may be beneficial to dissipate heat from the photoreactor assembly. As indicated above, providing a (flow of) gas may cool the photoreactor assembly. Additionally or alternatively, the photoreactor assembly may in embodiments comprise a heatsink. Heatsinks are known in the art. The term “heatsink” (or heat sink) may especially be a passive heat exchanger that transfers the heat generated by device, such as an electronic device or a mechanical device, to a fluid (cooling) medium, often air or a liquid coolant. Thereby, the heat is (at least partially) dissipated away from the device. A heatsink is especially designed to maximize its surface area in contact with the fluid cooling medium which may be in contact with the heatsink. Hence, especially a heatsink may comprise a plurality of fins. For instance, the heatsink may be a body with a plurality of fins extending thereof. A heatsink especially comprises (more especially consists of) a thermally conductive material. The term “heatsink” may also refer to a plurality of (different) heatsinks.

In a further aspect, the invention provides a method for treating a fluid with light source radiation. In embodiments, the method comprises providing the fluid to be treated with the light source radiation in the reactor of the photoreactor assembly. In embodiments, the method may further comprise irradiating the fluid with the light source radiation. Hence, in specific embodiments the invention provides a method for treating a fluid with light source radiation, wherein the method comprises: (a) providing the fluid to be treated with the light source radiation in the reactor of the photoreactor assembly; and (b) irradiating the fluid with the light source radiation. In this way, reactants in the fluid (in the reactor chamber) may be exposed relatively homogeneously to the light source radiation. Therefore, the method of the invention may provide one or more of a highly controlled reaction environment, a high conversion and high throughput. Especially, embodiments described above in relation to the photoreactor assembly may also apply to the method of the invention.

In further embodiments, the method may comprise transporting the fluid through the reactor while irradiating the fluid with the light source radiation. Additionally or alternatively, the method may comprise controlling one or more of a spectral power distribution and an intensity of the light source radiation along one or more dimensions of the reactor. The one or more dimensions of the reactor may be selected from the group of height, length, width, and diameter. Additionally or alternatively, the method may comprise transporting the fluid through the reactor while providing an inert gas via at least one opening. Hence, in specific embodiments, the method comprises transporting the fluid through the reactor while (a) irradiating the fluid with the light source radiation and controlling one or more of a spectral power distribution and an intensity of the light source radiation along one or more dimensions of the reactor, wherein the one or more dimensions of the reactor are selected from the group of height, length, width, and diameter, and (b) providing an inert gas via at least one opening.

In (other) embodiments, the fluid may not be transported through the reactor during exposure with the light source radiation, but may essentially be stationary, e.g. in wells (or cuvettes). Hence, providing the fluid may in embodiments refer to flowing and may in other embodiments refer to filling.

It will be clear to the person skilled in the art that the phrase “configured to provide light source radiation to X” and similar phrases indicate that the light source radiation travels along a path crossing X. Hence, a light source may provide light source radiation to a reactor wall, wherein the light source radiation passes through the reactor wall into the reactor fluid (during operation).

As indicated above, the reactor assembly may comprise a light transmissive reactor window. The term “transmissive” in the phrase “transmissive to the light source radiation ”especially refers to the property of allowing the light source radiation to pass through (the wall). In embodiments, the one or more reactor walls, especially the at least one of the one or more reactor walls, may be translucent for the light source radiation. Yet, in further embodiments, the one or more reactor walls, especially the at least one of the one or more reactor walls, is transparent for the light source radiation. The term “transmissive” not necessarily implies that 100% of the light source radiation provided emitted to the reactor wall may also pass through the wall. In embodiments at least 50% of the light source radiation emitted to the reactor wall may pass through the reactor wall, such as at least 70%, especially at least 90%. In further embodiments, at least 95% of the light source radiation emitted to the reactor wall may pass through the reactor wall, such as at least 98%. A relative amount of light source radiation passing through the reactor wall may e.g. depend on the wavelength of the light source radiation.

In embodiments, at least one of the one or more reactor walls may have a plate shape, especially a curved (or “bent”) plate shape. The term “plate shape” may herein especially refer to a shape having two dimensions that are substantially larger than a third dimension, such as at least 10 times larger, especially at least 50 times larger, such as a 100 times larger. The term “plate shape” may herein also refer to a bent plate shape, such as the shape of a plate bent to a cylindrical shape. For example, the at least one of the one or more react walls may have a plate-like shape defining a tubular photoreactor chamber, especially a tubular photoreactor channel.

The term “pitch” may herein especially refer to the (shortest) (heart-to-heart) distance between repeating elements, such as in embodiments the (shortest) (heart-to-heart) distance between light sources in the light source arrangement.

In embodiments, at least part of the reactor may be defined by two parallel configured reactor walls. The two parallel configured reactor walls may especially define (or “provide”) a reactor volume.

In particular, in embodiments, the parallel configured reactor walls may be separated by a first distance d1 at the narrow sections and by a second distance d2 at the broad sections. In embodiments, d2may be selected from the range of 0.1-10 mm, such as from the range of 0.2-5 mm, especially from the range of 0.5-5 mm, and especially wherein d1/d2 is selected from the range of 0.1-0.95, such as from the range of 0.2-0.9, especially from the range of 0.5-0.9. The first distance d1 and the second distance d2 may especially correspond to circular equivalent diameters of the reactor chamber, such as circular equivalent diameters perpendicular to a flow path in the reactor chamber.

The reactor chamber may especially be divided into a plurality of reactor sections and inter reactor section channels, wherein adjacent reactor sections may be fluidly connected via the inter reactor section channels.

The photoreactor assembly may, in embodiments, comprise a temperature control element, especially a temperature control channel. The temperature control element may be configured to control the temperature of the reactor, especially of the reactor fluid. The temperature control element may especially comprise a cooling element.

In embodiments, one or more of a spectral power distribution of the light source radiation and an intensity of the light source radiation may be controllable, especially the spectral power distribution, or especially the intensity.

In specific embodiments, two or more of the plurality of light sources may provide light source radiation having different spectral power distributions. For instance, a first light source may be configured to generate UV radiation and a second light source may be configured to generate visible radiation. In specific embodiments, the photoreactor assembly may comprise two or more light sources configured at different positions along the reactor chamber, especially along a flow path of the fluid.

The term “wavelength” may herein also relate to a plurality of wavelengths. The term may especially refer to a wavelength distribution.

In further embodiments, the photoreactor assembly may further comprise a control system. The control system may especially be configured to control the photoreactor assembly. For instance, in embodiments, the control system may be configured to control a flow of fluid through the reactor. In further embodiments, the control system may be configured to control a composition of the fluid. In further embodiments, the control system may be configured to (independently) control the plurality of light sources. In further embodiments, the control system may be configured to control the temperature control element.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g.

measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

During use of the photoreactor assembly, it may be beneficial to temporally and/or spatially vary the spectral power distribution of the light source radiation. For instance, different spectral power distributions may be successively provided to the reactor, especially to the reactor chamber, more especially to the fluid, for successive chemical reactions, or for controlling, for instance, algal growth phenotypes. Similarly, it may be beneficial to temporally and/or spatially vary the intensity of the light source radiation.

Hence, in embodiments, the control system may be configured to temporally vary one or more of the spectral power distribution and the intensity of the light source radiation, especially the spectral power distribution, or especially the intensity.

In further embodiments, the control system may be configured to control the one or more of the spectral power distribution and the intensity of the light source radiation, especially the spectral power distribution, or especially the intensity, along one or more dimensions of the reactor. In further embodiments, the one or more dimensions of the reactor may be selected from the group of height, length, width, and (circular equivalent) diameter.

It will be clear to the person skilled in the art, that also a combination of temporal and spatial control is possible.

In embodiments, the reactor fluid may flow through the reactor, especially the reactor chamber, or especially the reactor volume, along a flow path (or fluid path). In particular, the reactor may comprise a reactor inlet and a reactor outlet, wherein the reactor fluid, during use of the reactor, flows from the reactor inlet to the reactor outlet along the flow path, i.e., the flow path may be a path through the reactor chamber from the reactor inlet to the reactor outlet.

The reactor assembly may be used for treating a fluid. As a result, (photosensitive) reactants in the fluid may react. Moreover, the term “treating the fluid with light source radiation” may in embodiments relate to executing a (photochemical) reaction on (reactants in) the fluid.

Herein also the term “irradiating the fluid” such as in the phrase “irradiating the fluid with the light source radiation” is used. The term may especially relate to providing light source radiation to the fluid. Hence, herein the terms “providing light source radiation (to the fluid)” and the like and “irradiating (the fluid with) light source radiation” may especially be used interchangeably. Moreover, herein the terms “light” and “radiation” may be used interchangeably, especially in relation to the light source radiation.

In a further aspect, the invention may provide a method for treating a fluid with light source radiation. Especially, the method may comprise providing the fluid (to be treated with the light source radiation) in the reactor, especially in the reactor chamber, of the photoreactor assembly according to any one of the preceding claims. The method may further comprise irradiating the fluid with the light source radiation. Hence, in specific embodiments, the invention provides a method for treating a fluid with light source radiation, wherein the method comprises: providing the fluid to be treated with the light source radiation in the reactor of the photoreactor assembly according to the invention; and irradiating the fluid with the light source radiation. In embodiments, the method may comprise transporting the fluid through the reactor, especially while irradiating the fluid with the light source radiation.

In further embodiments, the method may comprise controlling one or more of a spectral power distribution and an intensity, especially a spectral power distribution, or especially an intensity, of the light source radiation along one or more dimensions of the reactor. The one or more dimensions of the reactor may especially be selected from the group comprising height, length, width, and (circular equivalent) diameter.

Irradiating the fluid with the light source radiation may induce a photochemical reaction. In embodiment, the (photochemical) reaction comprises a photocatalytic reaction. In embodiments, the method further comprises providing a photocatalyst and or photosensitizer to the (reactor) fluid prior to and/or during irradiating the (reactor) fluid with the light source radiation.

In embodiments, the method comprises a batch process. In other embodiments, the method comprises a continuous process. Hence, in specific embodiments, the method comprises transporting the fluid through the reactor while irradiating the fluid with the light source radiation. In other specific embodiments, the method comprises providing the fluid in the reactor and (subsequently) irradiating the fluid with the light source radiation.

The photoreactor assembly may especially comprise one or more temperature control elements (described herein). The method may further comprise transporting a temperature control fluid through and/or along one or more of the temperature control elements.

In yet further embodiments, the method comprises selecting the light source radiation from one or more of UV radiation, visible radiation, and IR radiation, prior to irradiating the fluid with the light source radiation. The light source radiation may especially be selected by selecting the plurality of light sources to generate the (selected) light source radiation. The light source radiation may further be selected based on the fluid to be treated, especially a (photosensitive) reactant and/or photocatalyst and/or photosensitizer in the fluid.

In further embodiments, one or more of the light sources are controlled to radiate different intensities and/or wavelength distributions.

Many photochemical reactions are known, such as dissociation reactions, isomerization or rearrangement reactions, addition reactions and substitution reactions, and, e.g., redox reactions. In embodiments, the (photochemical) reaction comprises a photocatalytic reaction. Photochemical reactions may especially use the energy of the light source radiation to change a quantum state of a system (an atom or a molecule) (that absorbs the energy) to an excited state. In the excited state, the system may successively further react with itself or other systems (atoms, molecules) and/or may initiate a further reaction. In specific embodiments, a rate of the photochemical reaction may be controlled by an added (photo-)catalysts or photosensitizer. The terms “treating”, “treated” and the like, used herein, such as in the phrase “treating a fluid with the light source (light)” may especially thus relate to performing a photochemical reaction on a relevant (especially photosensitive) system (atom or molecule) in the fluid, especially thereby elevating the system (atom, molecule) to a state of higher energy and especially causing the further reaction. In embodiments a photoactive compound may be provided to the fluid prior and/or during the irradiation of the fluid. For instance, a photocatalyst and/or a photosensitizer may be added to start and/or promote/accelerate the photochemical reaction.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-E schematically depict embodiments of the photoreactor assembly,

FIG. 2A-B schematically depict embodiments of the light source arrangement; and

FIG. 3 schematically depicts further embodiments of the photoreactor assembly. The schematic drawings are not necessarily on scale.

FIG. 4A shows simulation results of the irradiance distribution in the reactor obtained with a light source and reflector arrangement of the prior art.

FIG. 4B shows simulation results of the irradiance distribution in the reactor obtained with a light source and reflector arrangement according to the invention.

### DETAILED DESCRIPTION OF THE EMBODIMENTS

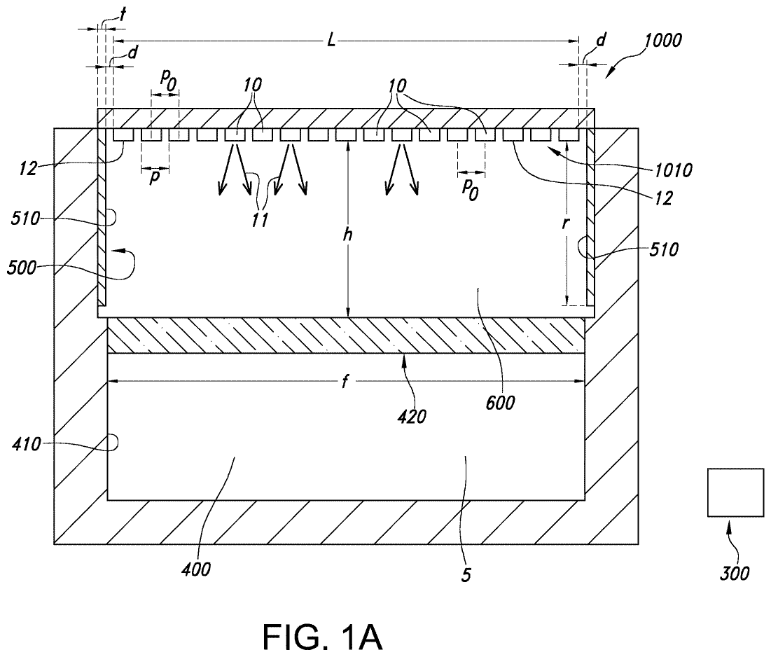

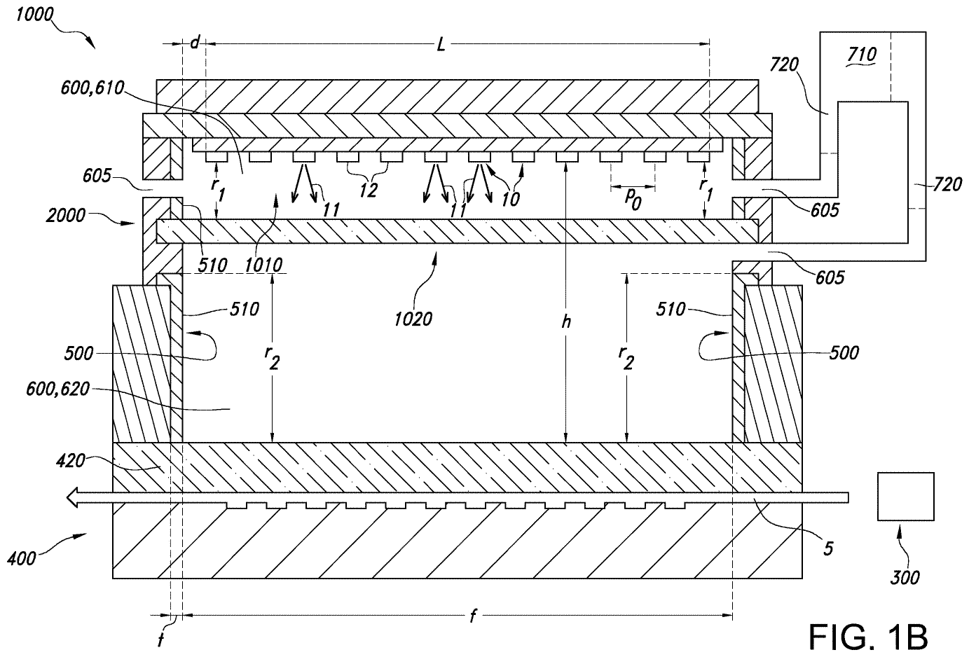

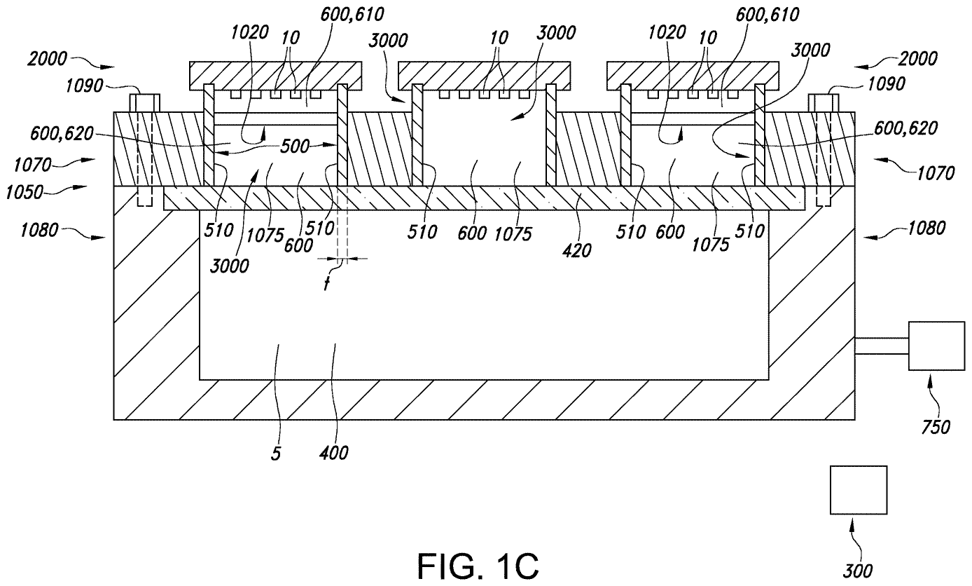

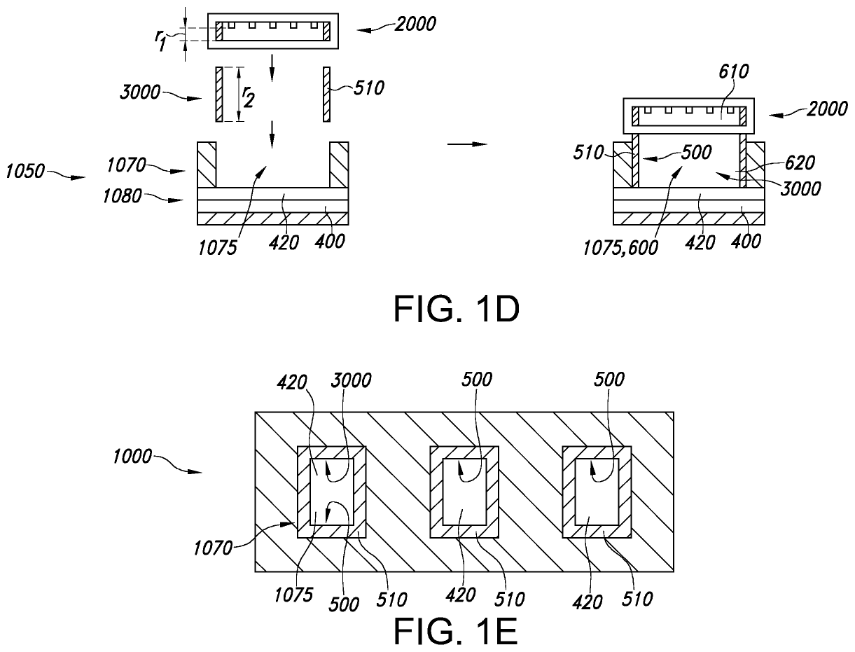

FIG. 1A schematically depicts an embodiment of the photoreactor assembly 1000. The photoreactor assembly comprises a reactor 400, a light source arrangement 1010 and a reflector arrangement 500. The light source arrangement 1010 comprises a plurality of (solid state) light sources 10 configured to generate light source radiation 11, especially light source radiation 11 selected from one or more of UV radiation, visible radiation, and IR radiation. In particular, each (solid state) light source 10 may comprise a light emitting surface 12, wherein the light emitting surface 12 emits the light source radiation 11. The solid state light sources 10 have shortest heart-to-heart distances p₀.

In embodiments, the solid state light sources 10 may be configured in an n*m array, wherein one of n and m is at least 1, such as at least 2, and another one of n and m is at least 5. Hence, the array may in embodiments be a 1*5 array or larger, more especially a 1*8 array, or larger, yet more especially a 1*10 array, or larger. Yet, in embodiments, the solid state light sources may be configured in a 2*5 or larger array. More especially, the solid state light sources may be configured in a 2*8 or larger array, like a 2*10 or a larger array. In embodiments, the array may have width L perpendicular to an axis of elongation of the photoreactor assembly 1000. In further embodiments, the solid state light sources within the array may have shortest edge-to-edge distances p.

The reactor 400 may be configured for hosting a fluid 5 to be treated with the light source radiation 11. The reactor 400 may comprise one or more reactor walls 410. The reactor may further comprise a light transmissive reactor window 420. The light transmissive reactor window 420 may be configured in a radiation receiving relationship with the solid state light sources 10. The light transmissive reactor window 420 may especially be transmissive for the light source radiation 11. The solid state light sources 10 of the light source arrangement 1010 may be configured at a second distance (h) from the light transmissive reactor window 420. The second distance h may be selected from the range of p₀-25*p₀, such as from the range of 3*p₀-20*p₀. In embodiments, the reactor 400 may have width f perpendicular to an axis of elongation of the photoreactor assembly 1000.

In embodiments, 0.5≤L/f≤1, such as 0.7≤L/f≤0.99, like as 0.8≤L/f≤0.98. Other values, however, may also be possible.

The reflector arrangement 500 may comprise one or more reflectors 510. The one or more reflectors 510 may be selected such that a reflection of the light source radiation 11 under perpendicular irradiation of the one or more reflectors 510 is at least 90%.

Further, reference d indicates a shortest third distance between the solid state light sources 10 and the one or more reflectors 510. Especially, the shortest distance d may be selected from the range of 0*p₀-5*p₀ such as 0.1*p₀- 5 *p₀.

The one or more reflectors 510, the light source arrangement 1010, and the light transmissive reactor window 420 may form at least part of a light chamber 600. More specifically, the one or more reflectors 510, the light source arrangement 1010, and the light transmissive reactor window 420 may form the light chamber 600. The one or more reflectors 510 may be configured to prevent escape from at least part of the light source radiation 11 from the light chamber 600. In the depicted embodiment, the one or more reflectors 510 have a reflector height r. In embodiments, the reflector height r may be selected from the range of at least 0.9*h.

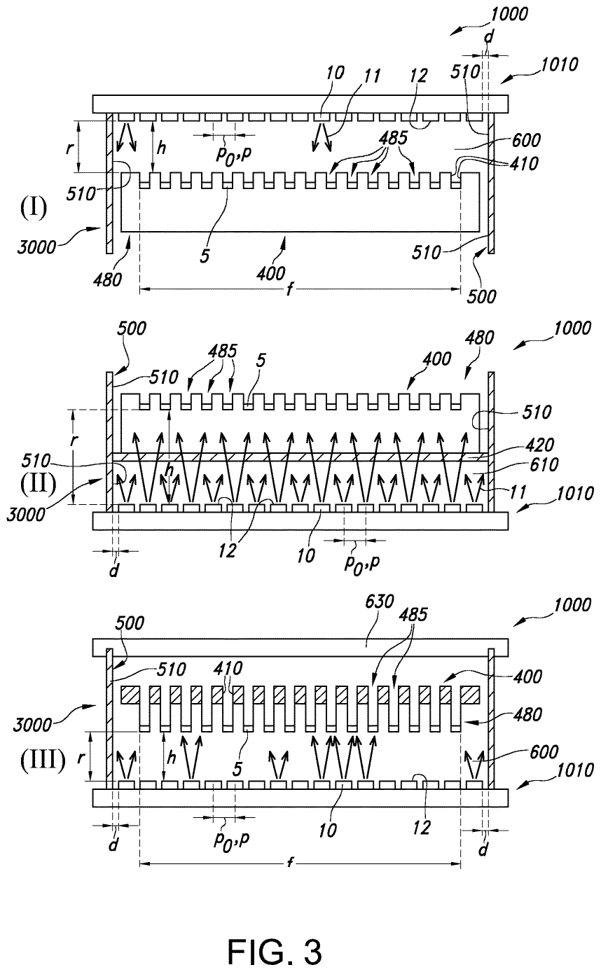

FIG. 1A also schematically depicts embodiments of the method of the invention. The method may comprise providing the fluid 5 to be treated with the light source radiation 11 in the reactor 400 of the photoreactor assembly 1000. Especially, the method may comprise irradiating the fluid 5 with the light source radiation 11. In embodiments, the fluid may be stationary (see also FIG. 3). In other embodiments, the method may comprise transporting the fluid 5 through the reactor 400 while irradiating the fluid 5 with the light source radiation 11 and controlling one or more of a spectral power distribution and an intensity of the light source radiation 11 along one or more dimensions of the reactor 400. The one or more dimensions of the reactor 400 may be selected from the group of height, length, width, and diameter.

Reference 300 refers to a control system. The control system 300 may control the light sources 10. Alternatively or additionally, the control system may control one or more parameters like pressure of the liquid 5, temperature of the liquid 5, gas flow in the light chamber 600 (see also below), etc.

FIG. 1B schematically depicts an embodiment in which the light chamber 600 has one or more openings 605. The one or more openings 605 may in embodiments have cross-sectional areas A1 having circular equivalent diameters Dᵢ, such that a sum of the area of all openings (Σ(π*(Dᵢ/2)²) is equal to or less than 5% of the total reflector area, such as up to about 1%.

The photoreactor assembly 1000 may further comprise a gas source 710 and a gas transport system 720. The gas transport system 720 may be fluidically coupled with at least one opening 605 of the one or more openings. The gas source 710 and gas transport system 720 may in embodiments be configured to flow an inert gas, during an operational mode of the photoreactor assembly 1000 into the light chamber 600.

In the depicted embodiment, the photoreactor assembly 1000 comprises a first light chamber 610 and a second light chamber 620. The first light chamber 610 and the second light chamber 620 may be separated by a light source arrangement window 1020. The light source arrangement window 1020 may in embodiments be transmissive for the light source radiation 11. The light emitting surface 12 of the plurality of light sources 10 may be configured in the first light chamber 610. The second light chamber 620 may at least partly be defined by the light transmissive reactor window 420 and the light source arrangement window 1020. In embodiments, the first light chamber 610 may comprise at least part of the one or more reflectors 510 having a first reflector height r1 and/or the second light chamber 620 may comprise at least part of the one or more reflectors 510 having a second reflector height r2. In embodiments, the reflector height r may be the sum of the first reflector height r1 and the second reflector height r2. Note that in FIG. 1b, by way of example the second reflector height r2 is not over the entire height of the second light chamber 620. In other embodiments, the reflector height r2 may essentially be equal to the height of the second light chamber 620.

The gas transport system 720 may be fluidically coupled with one or more of the first light chamber 610 and the second light chamber 620. In the depicted embodiment, a single gas source may be fluidically coupled with the first light chamber 610 and the second light chamber 620. In alternative embodiments, a first gas source may be fluidically coupled with the first light chamber 610 and a second gas source may be fluidically coupled with the second light chamber 620.

Here, by way of example a single gas transport system 720 and gas source 710 are depicted. However, there may be one or more gas sources 710. Further, there may be one or more gas transport systems 720. Further, the gas pressure and/or gas composition of the first light chamber 610 and the second light chamber 620 may not necessarily be coupled. The dashed lines in the gas transport system 720 and/or the gas source 710 may e.g. indicate that valves or other control means may control the gas pressure in the light chambers 610,620 individually. Also the gas compositions may be different in embodiments.

Hence, the method may further comprise transporting the fluid 5 through the reactor 400 and providing an inert gas 611 via at least one opening 605.

FIG. 1C schematically depicts an embodiment of the photoreactor assembly 1000 comprising a light generating unit 2000 and a frame element 3000. The light generating unit 2000 comprises the first light chamber 610 and the light source arrangement window 1020. The frame element 3000, the light source arrangement window 1020 of the light generating unit 2000, and the light transmissive reactor window 420 define the second light chamber 620.

The photoreactor assembly 1000 may further comprise a pressurizing device 750. The pressurizing device 750 may in embodiments be configured to impose a pressure on the fluid 5 during an operational mode of the photoreactor assembly 1000.

The photoreactor assembly 1000 may in embodiments comprise a holding structure 1050 comprising two parts 1070,1080, associated to each other via connector elements 1090. The light transmissive reactor window 420 may be configured in contact with a first part 1070 of the two parts 1070,1080. In embodiments, the holding structure 1050 may be configured to keep the light transmissive reactor window 420 in place. Especially, the first part 1070 may in embodiments comprise a hollow structure 1075. In embodiments, the light source arrangement 1010 may be configured over the hollow structure 1075 or may be at least partly configured in the hollow structure 1075.

In the depicted embodiment, the frame element 3000 is configured in the hollow structure 1075. The frame element 3000 may in embodiments especially comprise at least part of the one or more reflectors 510.

By way of example, FIG. 1c schematically depict two different options, with one not including a light source arrangement window 1020, and left and right thereof including such light source arrangement window 1020. The middle embodiment may include a frame element 3000, which together with the light generating unit 2000 and the light transmissive reactor window 420 may provide the light chamber 600.

FIG. 1D schematically depicts a possible method to provide arrangements as schematically depicted in FIG. 1C. Here, the frame element 3000 comprising the reflectors 510 may be configured in the hollow structure. The frame element 3000 may be closed with the light generating unit 2000. Note that the frame element 3000 and the light generating unit 2000 may also be a single unit. Optionally, the frame element 3000 may also be closed at the reactor side with a radiation transmissive front cover (not depicted). Hence, in embodiment the frame element 3000 may comprise of or may be functionally coupled with a radiation transmissive front cover. Hence, in specific embodiments, there may be 2-3 radiation transmissive windows between the light sources 10 and the reactor fluid.

FIG. 1E schematically depicts a top view, but without the light source arrangement 1010 or light generating unit 2000 of the arrangement of FIG. 1C. Referring to this figure, it may be clear that the reflector 510 may effectively comprise one or more reflectors 510, like four reflectors 510, forming a reflective enclosure. However, the reflector 510 may also consist of a single reflector, shaped into a shape with four sides. Hence, in embodiments the frame element 3000 may comprise one or more reflectors 510.

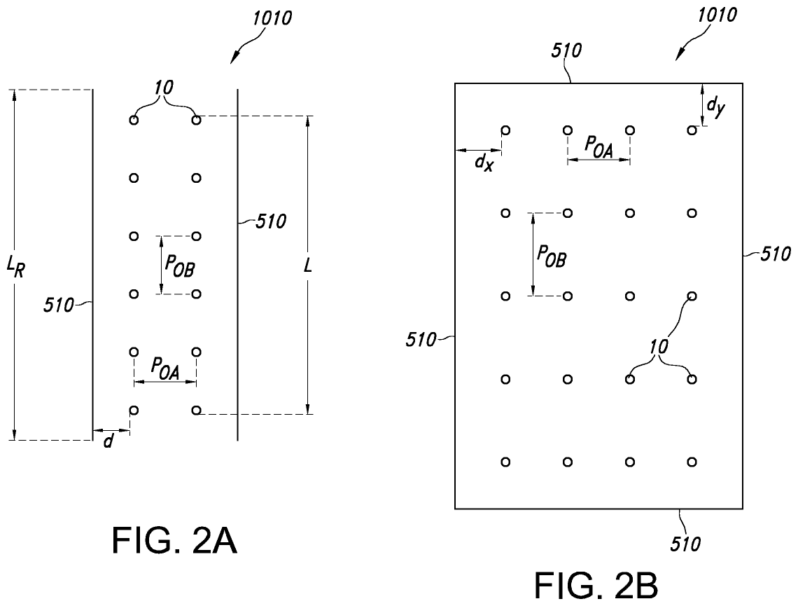

FIG. 2A schematically depicts an embodiment of the light source arrangement 1010 comprising the plurality of solid state light sources 10. In the depicted embodiment, the light source arrangement 1010 comprises an array of 2*6 solid state light sources 10. In a first direction (here horizontally), the light sources 10 are configured at heart-to-heart distances p_{0A}. In a second direction (here vertically), the light sources 10 are configured at heart-to-heart distances p_{0B}. In embodiments, the photoreactor assembly 1000 may comprise reflectors 510 in one direction (here the reflectors 510 are arranged vertically to reflect light source radiation 11 in a horizontal direction). The reflectors 510 and solid state light sources 10 may be configured such that a shortest third distance d between the solid state light sources 10 and (at least one of) the one or more reflectors may be selected from the range of 0.1*p₀-5*p₀, such as from the range of 0.4*p₀-0.6*p₀. In embodiments, P₀-P_{0A}. In alternative embodiments, P₀=P_{0B}. The reflectors 510 may have a reflector length L_{R}.

In further embodiments, the (plurality of) solid state light sources 10 may be configured in a regular array. In such embodiments, the shortest heart-to-heart distances po is a smallest pitch p (here, p=p₀) of the plurality of solid state light sources 10.

FIG. 2B schematically depicts another embodiment of the light source arrangement 1010 comprising the plurality of solid state light sources 10. In the depicted embodiment, the light source arrangement 1010 comprises an array of 4×5 solid state light sources 10. In a first direction (here horizontally), the light sources 10 are configured at heart-to-heart distances poA. In a second direction (here vertically), the light sources 10 are configured at heart-to-heart distances poB. In embodiments, the photoreactor assembly 1000 may comprise reflectors 510 in two directions. The reflectors 510 and solid state light sources 10 may be configured such that a shortest third distance d between the solid state light sources 10 and (at least one of) the one or more reflectors may be selected from the range of 0.1*p₀-5*p₀, such as from the range of 0.4*p₀-0.6*p₀. In embodiments, P₀=P_{0A}. In alternative embodiments, P₀=P_{0B}. Thus, in specific embodiments, a shortest horizontal third distance dₓ may be selected from the range of 0.1*p_{0A}-5*p_{0A}, such as from the range of 0.4*p_{0A}-0.6*p_{0A}. Additionally or alternatively, the shortest horizontal third distance dₓ may be selected from the range of 0.1*p_{0B}- 5*p_{0B}, such as from the range of 0.4*p_{0B}-0.6*p_{0B}. Additionally or alternatively, a shortest vertical third distance dy may be selected from the range of 0.1*p_{0A}-5*p_{0A}, such as from the range of 0.4*p_{0A}-0.6*p_{0A}. Additionally or alternatively, the shortest vertical third distance d_{y} may be selected from the range of 0.1*p_{0B}-5*p_{0B}, such as from the range of 0.4*p_{0B}-0.6*p_{0B}.

FIG. 3 schematically depicts embodiments of the photoreactor assembly 1000 wherein the reactor 400 comprises static fluid. In such embodiments, the reactor 400 may comprise a well-plate or an array of cuvettes. Here, the reactor 400 may comprise a reactor support body 480 comprising an array of reactor sections 485. As schematically depicted, the photoreactor assembly 1000 may be configured such that during operation of the photoreactor assembly 1000, the reactor sections 485 are irradiated with the light source light from above the reactor sections 485 or from below the reactor sections 485. Hence, in embodiments the invention also provides a parallel photoreactor, whereby multiple sections may be exposed in parallel without flow of the reaction fluid between the exposed locations. This configuration can be exposed from topside or bottom side, and can have a top/bottom cover to reflect back non-absorbed light and prevent light leakage.

Embodiment I schematically depicts a photoreactor assembly 1000 without light transmissive window 420, whereas embodiment II schematically depicts a photoreactor assembly 1000 comprising such light transmissive window 420. Embodiment I is lit from above, whereas embodiments II and III are lit from below. Hence, in such embodiments the reactor support body 480 comprises material that is transmissive for the light source radiation 11. Yet, further supplementary reflectors may be applied, like cover reflector 630 in embodiment III. An equivalent to cover reflector 630 may be applied in embodiment II, but is not depicted. Further, an equivalent bottom reflector may be applied in embodiment I. In this way, escape of part of the light source radiation 11 may be prevented.

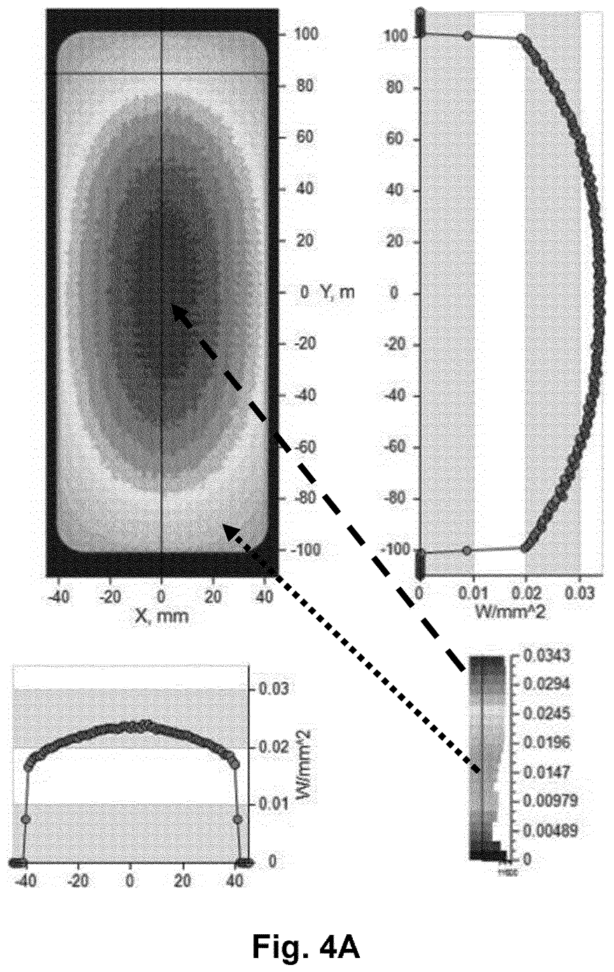

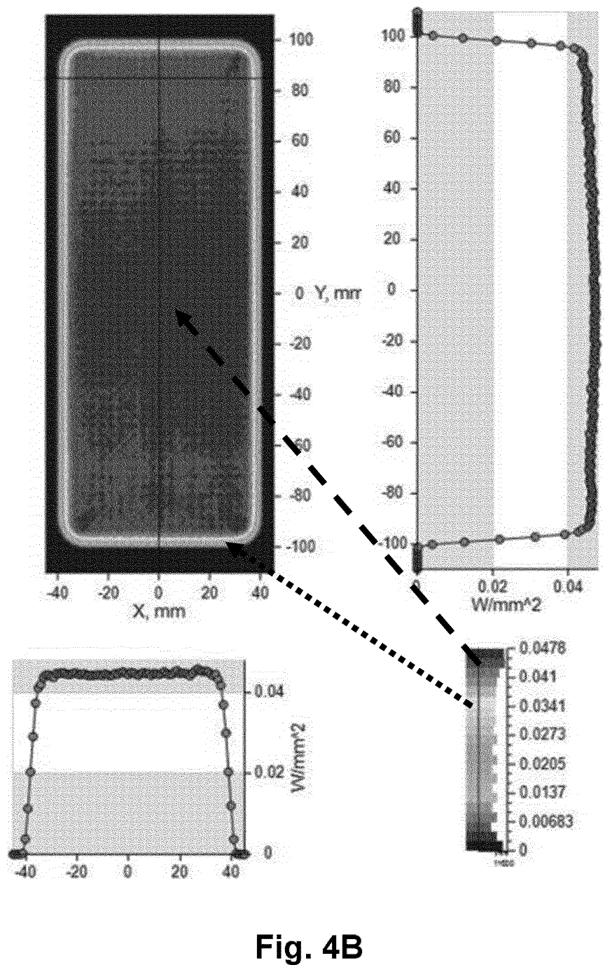

FIG. 4A shows simulation results of the irradiance distribution in the reactor obtained with a light source and reflector arrangement of the prior art (i.e. prior art systems). As shown in FIG. 4A, the irradiance distribution is not constant over the length axis and width axis in the reactor. Close to the sides of the reactor the intensity decreases. Thus, the light source radiation of prior art systems have a relatively low uniformity, which result in local variations in exposure and therefore less reliable results.

FIG. 4B shows simulation results of the irradiance distribution in the reactor obtained with a light source and reflector arrangement according to the invention. As shown in FIG. 4B, the irradiance distribution is constant over the length and width axes in the reactor. Close to the sides of the reactor the intensity does not decreases. Thus, the light source radiation of the photoreactor assembly of the invention provides a (relatively) high uniformity, which may prevent or reduces local variations in exposure and therefore results in a (relative) high efficiency and reliable results.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment, but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

In photochemical reactors photons may be used to initiate a chemical reaction. The reaction rate may be limited by the penetration of the light in the fluid containing the reactants, and by the refreshment rate of the chemicals. For scientific purposes a plurality of small batch reactor vessels may be used, combined in a cuvette tray or cavity plate reactor.

For commercial purposes flow reactors may be common, like plate reactors. These plate reactors may offer the advantage of a large ratio of surface area versus volume. Refreshment of the reaction liquid at the surface may be enhanced by turbulent flow in meandering channels of the microflow module plates. The pressure in the meandering channels can be very high, for instance 20 bar, so the plate reactor may have to be designed with great care. In general, the plate reactors may be made of (hard) glass in a frame/holder of stainless steel or some other high strength material. Sometimes additional safety glass plates are included in the design of the reactor.

To obtain large conversion rates under many different conditions, a light source with a high and uniform light output may be desired. In this way the wavelength-dependent irradiance at the position of the cuvettes, cavities, or channels will not be the limiting factor in the chemical process.

High power light sources with relevant wavelengths for photochemical reactions exist, but in most cases the light source and the reactants/photocatalysts may be separated by a distance (required for supporting frame/holder and other safety elements, like cover glass and ATEX inert gas chamber, and also to separate reactor and light source to facilitate replacement of the elements individually). The materials used for the reactor frame/holder may be selected for their strength. Generally, the reflectivity of these materials for wavelengths of interest is low (especially in the wavelength region below 400 nm). As a consequence, the optical efficiency of the light source+reactor combination may be low, and the uniformity of the irradiance (both in terms of total value, and in wavelength-dependent irradiance) may be low, due to the blocking effect of the construction of the reactor. This may lead to different chemical conversion rates or even different reaction products in different parts of the reactor.

We propose a light source with a high-density grid of solid state light sources, such as LEDs, emitting light with a specific wavelength, with a highly reflective reflector that fits within the (inner) dimensions of the frame/holder of the reactor. The reflector may act as an air lightguide and mixing rod, providing uniform irradiance over the whole area of the reaction fluid (so the whole (set of) channels in a plate reactor, or all individual cuvettes in a tray or cavities in a cavity plate).

In embodiments, the LED engine (which may be functionally coupled to the reactor) may comprise a PCB with a densely packed array of LEDs, a heatsink for heat management, a driver for powering the LEDs, a frame/housing around the array of LEDs, with highly reflective walls facing the LEDs, optionally comprising a cover glass plate. The inner dimensions of the frame/housing may be adjusted to the dimensions of the frame/holder of the reactor or cavity plate (e.g. 96 Well), an extension of the frame in the form of a thin-walled highly reflective reflector, that fits inside the frame/holder of the photochemical reactor. The extension may be connected to the frame/housing around the LEDs, or may be a separate component (a reflector insert). Alternatively, the highly reflective reflector insert may be physically attached to the metal frame/holder of the reactor or cavity plate (e.g. 96 Well).

The size of the exit window of the LED engine without reflector may match the size of the openings in the frame/holder of the photochemical reactor. The optical efficiency of an existing system (total optical power arriving in the reactor plate divided by optical power generated by the LED engine) may be in the order of 60% (assuming that the reflectivity of the frame/holder material is 50%. The maximum irradiance, in the middle of the irradiated spot, may be in the order of 34 m W_{optical}/mm², while the irradiance at the top and bottom side may be only around 20 mW_{optical}/mm² , i.e. almost a factor 2 lower resulting in lower conversion rates for reactants flowing at the edge of the reactor.

In contrast, the optical efficiency of the system of the invention may be 97%, the maximum irradiance may be 48 mW optical/mm². Another advantage of this LED engine with reflector may be that the light of individual LEDs may be mixed along the length of the light path, so variations in spectrum and radiant flux between individual LEDs may be cancelled out. Results show a much better homogenous distribution of the light source light then when the parameters described herein are not applied.

The extending reflector insert may be an integral part of the LED engine, or it may be a removable part. The advantage of the latter embodiment is that the reflector can be easily cleaned or replaced in case it is damaged or not functioning correctly anymore.

The LED engine, or more specifically the compartment between PCB with LEDs and cover glass, may be flushed with a specific (protective) gas for cooling purposes or for extension of the lifetime of the LED engine.

In another embodiment the highly reflective part between the light source may not cover all four side of the reactor frame. For example, only 2 reflectors at the short sides may be sufficient when only uniformity in the vertical direction is needed, or 2 reflectors on the long side to obtain uniform exposure in horizontal direction.

In the embodiments described above the reflective walls may be oriented perpendicular to the LED board. In another embodiment the orientation of the walls may be not exactly vertical, but under an angle or in a curved shape. In this embodiment the area of the LED engine and the exposed reactor area may be different.

The protective cover glass of the LED engine may have optical structures for shaping the light beam.

The protective cover glass may contain a small band filter coating or an AR (anti reflective) coating.

In yet another embodiment the frame/housing around the array of LEDs may be the extended reflector, and protective cover glass of the LED engine may be placed at large distance from the LEDs at the exit window of the reflector.

1. A photoreactor assembly comprising a reactor, a light source arrangement, and a reflector arrangement; wherein:
the light source arrangement comprises a plurality of solid state light sources configured to generate light source radiation selected from one or more of UV radiation, visible radiation, and IR radiation; wherein the plurality of solid state light sources configured in a regular n*m array having a smallest pitch, wherein one of n and m is at least 2, and another of n and m is at least 2, and another one of n and m is at least 5;
the reactor is configured for hosting a fluid to be treated with the light source radiation; wherein the reactor comprises one or more reactor walls and a light transmissive reactor window; wherein the light transmissive reactor window is configured in a radiation receiving relationship with the solid state light sources, and is transmissive for the light source radiation;
the solid state light sources of the light source arrangement are configured at a second distance from the light transmissive reactor window;
the reflector arrangement comprises one or more reflectors; wherein the one or more reflectors are selected such that a reflection of the light source radiation under perpendicular irradiation of the one or more reflectors is at least 90%;
the one or more reflectors, the light source arrangement, and the light transmissive reactor window form at least part of a light chamber; wherein the one or more reflectors are configured to prevent escape from at least part of the light source radiation from the light chamber; and
a shortest third distance between the solid state light sources and the one or more reflectors is selected from the range of 0*p₀-0.9*p₀, and the second distance is selected from the range of p₀-25*p₀.

2. The photoreactor assembly according to claim 1, wherein the shortest third distance (-is selected from the range of 0.4*p₀-0.6*p₀; wherein one of n and m is at least 8.

3. The photoreactor assembly according to claim 1, wherein the second distance is selected from the range of 3*p₀-15*p₀; wherein one of n and m is at least 5 and another one of n and m is at least 10.

4. The photoreactor assembly according to claim 1, wherein the one or more reflectors have a reflector height, wherein the reflector height is selected from the range of at least 0.9*h.

5. The photoreactor assembly according to claim 1, wherein the one or more reflectors, the light source arrangement, and the light transmissive reactor window form the light chamber; wherein the one or more reflectors are configured to prevent escape from at least part of the light source radiation from the light chamber.

6. The photoreactor assembly according to claim 1, comprising a first light chamber and a second light chamber, separated by a light source arrangement window; wherein the light emitting surface of the plurality of light sources are configured in the first light chamber; wherein the second light chamber is at least partly defined by the light transmissive reactor window and the light source arrangement window; and wherein the first light chamber comprises at least part of the one or more reflectors and/or wherein the second light chamber comprises at least part of the one or more reflectors.

7. The photoreactor assembly according to claim 1, wherein the light chamber has one or more openings; wherein the one or more openings have cross-sectional areas A1 having circular equivalent diameters Dᵢ, such that a sum of the area of all openings (S(p*(Dᵢ/2)²) is equal to or less than 5% of the total reflector area.

8. The photoreactor assembly according to claim 7, further comprising a gas source and a gas transport system, wherein the gas transport system is fluidically coupled with at least one opening of the one or more openings, and wherein the gas source and gas transport system are configured to flow an inert gas, during an operational mode of the photoreactor assembly into at least part of the light chamber.

9. The photoreactor assembly according to claim 8, wherein the gas transport system is fluidically coupled with one or more of the first light chamber and the second light chamber.

10. The photoreactor assembly according to claim 8, further comprising a control system configured to maintain a pressure in the light chamber or the second light chamber of up to 5 bar.

11. The photoreactor assembly according to claim 1, comprising (a) a light generating unit, wherein the light generating unit comprises the first light chamber and the light source arrangement window according to claim 6, and (b) a frame element, wherein the frame element, the light source arrangement window of the light generating unit, and the light transmissive reactor window define the second light chamber.

12. The photoreactor assembly according to claim 1, wherein the photoreactor assembly comprises a holding structure comprising two parts, associated to each other via connector elements; wherein the light transmissive reactor window is configured in contact with a first part of the two parts, and wherein the holding structure is configured to keep the light transmissive reactor window in place; wherein the first part comprises a hollow structure; wherein the light source arrangement is configured over the hollow structure or is at least partly configured in the hollow structure.

13. The photoreactor assembly according to claim 10, wherein the frame element is configured in the hollow structure; and wherein the frame element comprises at least part of the one or more reflectors.

14. The photoreactor assembly according to claim 1, wherein the reactor comprises a reactor support body comprising an array of reactor sections; wherein the photoreactor assembly is configured such that during operation of the photoreactor assembly, the reactor sections are irradiated with the light source light from above the reactor sections or from below the reactor sections.

15. A method for treating a fluid with light source radiation, wherein the method comprises: (a) providing the fluid to be treated with the light source radiation in the reactor of the photoreactor assembly according to claim 1; and (b) irradiating the fluid with the light source radiation.
